(19) United States
(12) Patent Application Publication
(10) Pub. No.: US 2026/0368990 A1
(43) Pub. Date: Nov. 19, 2026

(54) FACIAL APPEARANCE CAPTURE IN THE WILD

(71) Applicants: DISNEY ENTERPRISES, INC., Burbank, CA (US); ETH Zürich (Eidgenössische Technische Hochschule Zürich), Zürich (CH)

(72) Inventors: Yingyan XU, Zürich (CH); Sebastian Klaus WEISS, Zürich (CH); Derek Edward BRADLEY, Zürich (CH); Gaspard ZOSS, Zürich (CH); Kate Anne GADOLA, Greifensee (CH); Prashanth CHANDRAN, Zürich (CH)

(21) Appl. No.: 19/212,239

(22) Filed: May 19, 2025

(51) Int. Cl. G06T 15/00; G06T 7/55; G06T 15/04; G06T 17/20

(52) U.S. Cl. CPC G06T 15/005; G06T 7/55; G06T 15/04; G06T 17/20; G06T 2200/08; G06T 2207/30201; G06T 2207/30204; G06T 2215/12

(57) ABSTRACT

The present invention sets forth techniques for performing facial capture. The techniques include capturing, using a single camera having a fixed location, multiple images of a subject's face under fixed, arbitrary lighting conditions. The techniques also include selecting a set of input frames from the multiple images and generating a 3D facial mesh, a lighting environment representation, and one or more texture maps associated with each input frame. the techniques further include generating a 2D rendering of the subject's face and optimizing the 3D facial mesh, the lighting environment representation, and one or more texture maps based on the 2D rendering and one or more loss function values. The techniques generate a final 3D asset suitable for subsequent visual effects processing, including relighting, animation, expression transfer, and/or texture modification.

### BACKGROUND

### Field of the Various Embodiments

Embodiments of the present disclosure relate generally to capturing facial appearance from image observations, including all aspects of the related hardware, software, graphical user interfaces, and algorithms associated with implementing the contemplated systems, techniques, functions, and operations set forth herein,

### Description of the Related Art

In the fields of visual effects (VFX) and computer animation, facial capture techniques may reconstruct skin appearance as a collection of texture maps based on one or more image observations. For example, texture maps may describe diffuse albedo, specular intensity, roughness, and/or fine surface displacements associated with a subject's face. The reconstructed skin appearance may be further modified by subsequent VFX operations, such as relighting or texture editing. Reconstructed skin representations may be incorporated into, for example, telepresence applications, film or television production, video game production, or image editing applications.

Existing techniques for facial capture may require elaborate and precise studio lighting and/or capture arrangements. For example, existing techniques may require multiple cameras and/or multiple lights, with the positions of the subject, the light(s), and the camera(s) carefully calibrated. Further, existing techniques may require polarizing filters to separate diffuse and specular lighting, or may require high-quality three-dimensional (3D) facial geometry as an input.

Other existing techniques may attempt to perform facial capture “in the wild,” referring to performing facial capture outside of controlled environments such as studios or film sets. These techniques may relax some of the technical requirements associated with facial capture, but are still subject to significant constraints. For example, existing techniques may allow for arbitrary lighting conditions, while still requiring multi-view captures from multiple cameras. Other techniques may be constrained to a single directional light source, or a single light source that is co-located with a camera in an otherwise dark environment. Existing techniques may also ignore facial self-occlusion, where one or more portions of the face are shaded or not visible based on the positions of one or more light sources and the orientation of the face. The techniques may not be able to separate shading incident on a face from the appearance of the face itself.

As the foregoing illustrates, what is needed in the art are more effective techniques for capturing facial appearance from image observations.

### SUMMARY

One embodiment of the present invention sets forth a technique for performing facial appearance capture. The technique includes capturing multiple two-dimensional (2D) images depicting a subject's face and generating, for each of one or more of the 2D images, a three-dimensional (3D) facial mesh, a lighting environment representation, and one or more 2D texture maps. The technique also includes generating a 2D rendered image depicting the subject's face, based at least on the 3D facial mesh, the lighting environment representation, and the one or more 2D texture maps. The technique further includes optimizing one or more of the 3D facial mesh, the lighting environment representation, and the one or more 2D texture maps, based on a final loss value including one or more loss terms and regularization terms, and generating an output 3D asset including an optimized 3D facial mesh, an optimized lighting environment representation, and one or more optimized 2D texture maps.

One technical advantage of the disclosed techniques relative to the prior art is that the disclosed techniques require only a single fixed camera and are operable to perform facial capture under arbitrary static lighting conditions. The disclosed technique do not require high quality 3D face geometry as an input, and correctly model facial self-occlusion while generating appearance maps of the subject, allowing the disclosed techniques to separate shading from the captured facial appearance. Further, the disclosed techniques are operable to estimate the static environment lighting based on captured facial images. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 is a more detailed illustration of the capture engine of FIG. 1, according to some embodiments.

FIG. 3 is a flow diagram of method steps for performing facial capture, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

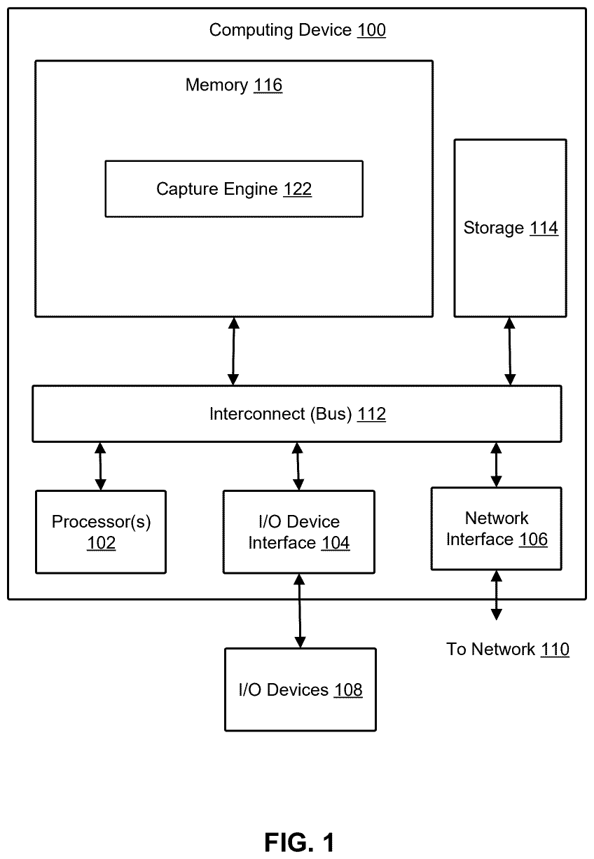

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run capture engine 122 that resides in a memory 116.

It is noted that the computing device described herein is illustrative and that any other technically feasible configurations fall within the scope of the present disclosure. For example, multiple instances of capture engine 122 could execute on a set of nodes in a distributed and/or cloud computing system to implement the functionality of computing device 100. In another example, capture engine 122 could execute on various sets of hardware, types of devices, or environments to adapt capture engine 122 to different use cases or applications. In a third example, capture engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Capture engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including capture engine 122.

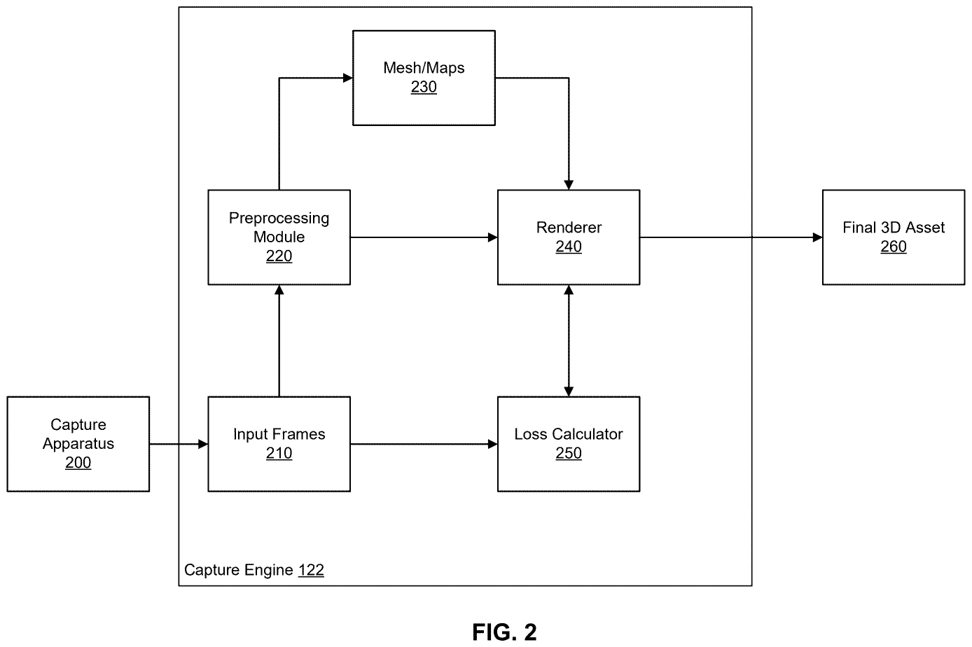

FIG. 2 is a more detailed illustration of capture engine 122 of FIG. 1, according to some embodiments. Capture engine 122 receives multiple images of a subject face from capture apparatus 200, and generates final 3D asset 260, including a 3D mesh representation of the subject's face and multiple 2D texture maps collectively representing the appearance of the subject's skin. Capture engine 122 includes, without limitation, input frames 210, preprocessing module 220, mesh/maps 230, renderer 240, and loss calculator 250.

In various embodiments, capture apparatus 200 includes a camera suitable for capturing 2D images of a subject, and a lighting environment. In various embodiments, the camera may include a still camera positioned at a known, fixed location in front of a subject. In other embodiments, the camera may include a video camera at a known, fixed location in front of the subject, where a video sequence captured by the video camera may be divided into individual frames each depicting the subject's face.

In various embodiments, the lighting environment may include an arbitrary arrangement of one or more natural and/or artificial light sources. The natural light source(s) may include direct and/or indirect sunlight, and the artificial light source(s) may include continuous, strobe, or flash illumination from one or more electrical light bulbs. In various embodiments, the lighting environment may be static, meaning that the locations and intensities of the various light sources remain fixed or substantially fixed while capture apparatus 200 obtains still images or a video sequence depicting the subject.

In various embodiments, a still camera included in capture apparatus 200 may obtain multiple images of a subject, e.g. 500-800 images. During image capture, the subject maintains a constant facial expression, and may rotate their head up, down, to the left, and/or to the right. In various embodiments, each of the horizontal and vertical angular displacements of the subject's head may encompass a range of approximately +30 degrees to −30 degrees from a central position, where the central position represents the subject facing the still camera directly and having horizontal and vertical displacements of zero degrees.

In other embodiments, a video camera included in capture apparatus 200 may obtain a video sequence of the subject having the same neutral facial expression and rotating their head through similar horizontal and vertical angular displacements. The duration of the video sequence may be based on a frame rate associated with the video camera and a desired number of individual frames to be subsequently extracted from the video sequence. For example, given a video camera having a frame rate of 25 frames per second, a captured video sequence having a length of 32 seconds is suitable to record 800 individual frames depicting the subject. Capture apparatus 200 transmits the individual still images or the captured video sequence to capture engine 122.

Capture engine 122 receives the still images or video sequence from capture apparatus 200 and generates input frames 210. In an embodiment including individual images captured from a still camera, capture engine 122 may designate a selected subset of still images, e.g., 250 still images, as input frames 210. Capture engine 122 may select input frames 210 via uniform distribution or any other suitable selection method. In an embodiment including a captured video sequence, capture engine 122 may convert the video sequence into a collection of individual frames, and select input frames 210 from the collection of individual frames. Capture engine 122 transmits input frames 210 to preprocessing module 220.

In various embodiments, preprocessing module 220 receives an input frame included in input frames 210, and generates an initial 3D mesh representing the subject facial geometry depicted in the input frame. Preprocessing module 220 also generates one or more initial 2D texture maps represent the subject's skin appearance, and an initial lighting environment representation describing the static lighting environment.

In various embodiments, preprocessing module 220 generates the initial 3D mesh via a 3D morphable model (3DMM). Preprocessing module 220 detects facial landmarks depicted in the input frame, and the 3DMM fits the initial 3D mesh to the detected facial landmarks based on a parameterized combination of blending weights associated with a principal component analysis (PCA) facial basis. In various embodiments, the 3DMM may also generate a binary face mask associated with the input frame, such that the initial 3D mesh is based on only the portion of the input frame associated with the subject's face. Preprocessing module 220 may calculate a photometric loss based on a comparison of the fitted mesh and the input frame, and a landmark loss based on the initial 3D mesh and the detected landmarks. Preprocessing module 220 may iteratively adjust one or more vertices included in the initial 3D mesh based on the photometric loss and/or the landmark loss. In various embodiments, preprocessing module 220 may also estimate a fixed camera location and orientation, as well as per-frame rigid head poses and neck rotation values.

Preprocessing module 220 generates an initial diffuse albedo texture map by averaging a projected texture across multiple input frames and computing a piece-wise constant version of the diffuse albedo texture map based on a predefined face segmentation. Preprocessing module 220 generates an initial specular intensity texture map including a greyscale depiction of the generated initial diffuse albedo texture map. Preprocessing module 220 may also generate an initial specular roughness texture map and an initial lighting environment representation describing the static lighting conditions. In various embodiments, the initial specular roughness texture map may be initialized as a constant texture having uniform pixel-wise values of, e.g., 0.5.

In various embodiments, the initial lighting environment representation may include a 2D texture map, where each pixel included in the 2D texture map includes an associated 3D direction, as well as a pixel color and intensity value corresponding to the light color and intensity from that direction. Preprocessing module 220 may initialize the lighting environment representation with random pixel-wise values drawn from a uniform distribution on the interval [0, 0.5].

Preprocessing module 220 generates mesh/maps 230, including the initial 3D mesh, the initialized lighting environment representation, and the initialized diffuse albedo, specular intensity, and roughness texture maps. Preprocessing module 220 transmits mesh/maps 230, along with the per-frame head poses and neck rotations, to renderer 240.

In various embodiments, renderer 240 includes a differentiable rendering engine and generates a 2D rendered image of a subject's face based on mesh/maps 230, the per-frame head poses, and the per-frame neck rotations. Based on the 2D rendered image, capture engine 122 may modify one or more of mesh/maps 230 via, for example, a gradient descent technique based on loss function and regularization values calculated by loss calculator 250 described below.

### Geometry Optimization

Renderer 240 may iteratively modify the geometry of the initial 3D mesh included in mesh/maps 230 by adjusting the positions of one or more vertices v included in the 3D mesh, where v represents an array of 3D vertex positions. At each iteration, renderer 240 updates v:

$$v ← v - {η ( I + {λ}_{geo} L )}^{2} \frac{\partial ℒ}{\partial v} \qquad Equation ( 1 )$$

where v∈R^{N×3} collects mesh vertex positions along rows, η is a learning rate, I is an identity matrix, L is the uniform Laplacian, and [symbol] is a loss function discussed below in the description of loss calculator 250. The hyper-parameter λ_{geo}>0 balances between the objectives of matching the input images and generating a smooth mesh. In various embodiments, λ_{geo} may equal 19, in order to apply a large learning rate for the geometry optimization while keeping the mesh smooth and self-intersection free. In various embodiments, renderer 240 may optimize the positions of one or more vertices v in a canonical unposed space shared by all frames. Renderer 240 may translate vertex optimizations into the canonical unposed space, based on the per-frame head poses and neck rotations received from preprocessing module 220.

### Shading Model

Renderer 240 calculates the outgoing total radiance L(ωₒ) in direction ωₒ by applying the standard rendering equation:

L(ωₒ)=∫_{Ω}f(x,ωᵢ,ωₒ)Lᵢ(ωᵢ)(ωᵢ·n)dωᵢ, Equation (2)

where f(x, ωᵢ, ωₒ) represents the bidirectional reflectance distribution function (BRDF), Lᵢ(ωᵢ) represents the incoming radiance from direction ωᵢ, and Ω represents the unit hemisphere centered around n containing all possible values for ωᵢ where (ωᵢ·n) is greater than zero.

In various embodiments, renderer 240 decomposes the BRDF f(x, ωᵢ, ωₒ) into a diffuse term f_{d} and a specular term fₛ. The diffuse term is given by the simple Lambertian model:

$${f}_{d} ( x ) = \frac{ρ ( x )}{π} , \qquad Equation ( 3 )$$

where ρ is the diffuse albedo given by the diffuse albedo texture map included in mesh/maps 230.

The specular term is given by

$${f}_{s} ( x , {ω}_{i} , {ω}_{o} ) = \frac{DGF}{4 ( {ω}_{i} \cdot n ) ( {ω}_{o} \cdot n )} , \qquad Equation ( 4 )$$

where D, G, and F are functions representing the Beckmann normal distribution, geometric attenuation and Fresnel terms, respectively.

Renderer 240 calculates the visibility of incoming illumination at each location included in the 3D mesh geometry, and determines the outgoing diffuse radiance L_{diffuse}(ωₒ) and the outgoing specular radiance L_{specular}(ωₒ). In various embodiments, renderer 240 assumes that the incoming illumination includes only direct illumination Lᵢ(ωᵢ) from the one or more light sources included in capture apparatus 200, and does not consider indirect illumination coming from, e.g., reflections.

When calculating the outgoing diffuse radiance, renderer 240 performs explicit ray tracing to calculate the total outgoing radiance and determines the diffuse component L_{diffuse}(ωₒ):

L_{diffuse}(ωₒ)=∫_{Ω}f_{d}(x)Lᵢ(ωᵢ)V(x,ωᵢ)(ωᵢ·n)dωᵢ Equation (5)

where V(x, ωᵢ) represents the visibility at surface point x from incoming light direction ωᵢ.

When calculating the outgoing specular radiance, renderer 240 applies the light source(s) Lᵢ described in the lighting environment representation, the half-vector h between the light direction ωᵢ and the viewing direction ωₒ, and a split-sum approximation:

L_{specular}(ωₒ)≈∫Ωfₛ(x,ωᵢ,ωₒ)(ωᵢ·n)dωᵢ∫_{Ω}Lᵢ(ωᵢ)D(h)(ωᵢ·n)dωᵢ Equation (6)

where the first term includes the material integral that depends on ωᵢ·n and the roughness. The second integral includes the lighting environment representation. In various embodiments, capture engine 122 may pre-compute one or both of the integral terms included in Equation (6), and store the pre-computed integrals as 2D texture maps. At rendering time, renderer 240 may substitute a texture lookup for the evaluation of one or both integral terms.

In a typical instance where the roughness r of the skin is much less than 1, renderer 240 may approximate the second integral term, because the value of the second integral term will be zero unless the angular separation between the incoming light direction ωᵢ and the reflected view direction ωᵣ is small:

∫_{Ω}Lᵢ(ωᵢ)V(x,ωᵢ)D(h)(ωᵢ·n)dωᵢ≈\grave{V}(x,ωᵣ)∫_{Ω}Lᵢ(ωᵢ)D(h)(ωᵢ·n)dωᵢ Equation (7)

where \grave{V}(x, ωᵣ) is the view-dependent specular visibility. In various embodiments, renderer 240 may set the view-dependent specular visibility equal to the light visibility in the reflected view direction ωᵣ, i.e., \grave{V}(x, ωᵣ):=V(x, ωᵣ). As a result, the specular outgoing radiance will equal zero if the reflected view direction ωᵣ is occluded. In other words, if no light sources are directly visible to a location x from a viewing direction ωᵣ, then the specular contribution to the outgoing radiance at the location x will be zero.

In other embodiments, renderer 240 may approximate the view-dependent specular visibility \grave{V}(x, ωᵣ) via Monte Carlo integration, such that the specular visibility may not exactly equal zero if the reflected view direction ωᵣ is occluded:

$${V}^{`} ( x , {ω}_{r} ) := \frac{1}{K} {Σ}_{k = 1}^{K} \frac{V ( x , {ω}_{k} )}{D ( {ω}_{k} )} \qquad Equation ( 8 )$$

where the K samples are drawn following the normal distribution of a specular lobe centered at point x, and D represents a probability density distribution of the specular lobe from which the K samples are drawn. Evaluating the visibility V at K different viewing angles ωₖ centered around ωᵣ smooths the visibility values for viewing angles for which the view-dependent specular visibility would otherwise equal exactly zero or exactly one. In contrast, the smoothed visibility values may include any values between zero and one.

Renderer 240 generates a rendered 2D image of the subject's face, based on the 3D facial mesh and the rendering equation (Equation (2)) described above. Renderer 240 transmits the rendered 2D image to loss calculator 250 described below.

### Visibility Prior Model

In an alternative embodiment, renderer 240 may calculate the visibility of each location on the 3D mesh using a visibility prior model. The visibility prior model includes a trained machine learning model operable to calculate the visibility of any point included in a previously unseen 3D facial mesh representation. The shading model discussed above recomputes the visibility V(x, ωᵣ) at each iteration, as the location of the 3D mesh vertices included in the points x may change during each iteration. In contrast, the visibility prior model may generate visibility values for locations x included in a 3D mesh based on a single shape code z derived from the 3D mesh vertex positions.

In various embodiments, the visibility prior model includes an implicit neural network that has been previously trained on a large dataset of 3D facial meshes, where each 3D facial mesh includes a shape code z and associated ground truth visibility values for each location included in the 3D facial mesh. In various embodiments, the shape code z may be generated by any suitable geometry processing network, or by a simple Principal Component Analysis (PCA) model.

In various embodiments, the visibility prior model may predict spherical harmonics coefficients, which may be queried with a given light direction to determine visibility values for points included in the 3D mesh. In these embodiments, the ground truth visibility data may include precomputed spherical harmonics coefficients calculated for each 3D facial mesh included in the training dataset. In other embodiments, the visibility prior model may model the spherical signed distance function (SSDF) as a multilayer perceptron (MLP). These embodiments are suitable if Spherical Gaussians are used as basis functions in the shading model, rather than spherical harmonics. Once trained, renderer 240 may query the visibility prior model with a shape code and vertex positions associated with a current iteration of the 3D facial mesh, as well as a light direction, and retrieve visibility values for each vertex included in the 3D facial mesh. As discussed above in the description of the shading model, renderer 240 generates a 2D image representing the subject's face, and transmits the 2D image to loss calculator 250.

In various embodiments, loss calculator 250 calculates one or more loss and/or regularization values included in a training loss function. In various embodiments, the training loss may include an L₁ data loss [symbol] _{mg}, an L₁ mask loss [symbol] ₘₐₛₖ, a Laplacian regularization term [symbol] _{Lap}, a diffuse regularization term [symbol] _{diffuse}, a white light regularization term [symbol] _{light}, and a roughness regularization term [symbol] _{rough}.

Loss calculator 250 computes the L₁ data loss [symbol] _{img} based on a pixel-wise comparison between the 2D rendered image received from renderer 240 and the corresponding image of the subject included in input frames 210. Loss calculator 250 computes the L₁ mask loss [symbol] ₘₐₛₖ based on a pixel-wise comparison of the binary face mask generated by preprocessing module 220 and a ground truth binary face mask generated by the MODNet technique or any other suitable portrait matting technique.

In various embodiments, the Laplacian regularization term [symbol] _{Lap} encourages the Laplacian of the optimized 3D facial mesh to remain close to the Laplacian of the initial 3D facial mesh generated by the 3DMM as discussed above:

$${ℒ}_{L a p} = {‖ L ( v - {v}_{init} ) ‖}_{2}^{2} \qquad Equation ( 9 )$$

Loss calculator 250 applies the white light regularization term [symbol] _{light} to the optimized environment map. The white light regularization term encourages the lighting values included in the lighting environment representation to remain close to white light in color value, to match the color value of typical natural and artificial light sources. Loss calculator 250 also applies the roughness regularization term [symbol] _{rough} to the optimized roughness texture map. In various embodiments, the roughness regularization term [symbol] _{rough} includes a total variation loss that encourages smooth transitions between areas of different roughness included in the optimized roughness texture map.

Loss calculator 250 applies the weak diffuse regularization term [symbol] _{diffuse} to encourage the diffuse render I_{diffuse} to be small if possible:

$${ℒ}_{diffuse} = {‖ {I}_{diffuse} ‖}_{2}^{2} \qquad Equation ( 10 )$$

The final loss function [symbol] is defined as:

[symbol]

:= [symbol] _{img}+λₘₐₛₖ [symbol] ₘₐₛₖ+λ_{Lap} [symbol] _{Lap}+λ_{light} [symbol] _{light}+λ_{rough} [symbol] _{rough}+λ_{diffuse} [symbol] _{diffuse}, Equation (11)

where each λ value represents a weight associated with the corresponding loss or regularization term. In various embodiments, the weights may be defined as:

λₘₐₛₖ=0.1, λ_{Lap}=10, λ_{light}=0.1

λ_{rough}=0.1, λ_{diffuse}=0.01 Equation (12)

Capture engine 122 iteratively modifies one or more values included in the 3D facial mesh, the 3D environment map, and the 2D texture maps, based on the value of the final loss function [symbol] . As renderer 240 is differentiable, capture engine 122 may employ a gradient descent technique to modify the one or more values. In various embodiments, capture engine 122 may iteratively optimize the 3D facial mesh, the 3D environment map, and the 2D texture maps for a predetermined number of iterations, e.g. 6000 iterations, or until the final loss function value is below a predetermined threshold. After optimization, renderer 240 generates final 3D asset 260, and capture engine 122 transmits final 3D asset 260 for subsequent processing and/or storage.

In various embodiments, final 3D asset 260 includes an optimized, high-quality 3D mesh representing the subject's face, as well as optimized diffuse albedo, specular intensity, and roughness texture maps. Final 3D asset 260 may also include an optimized 3D environment map describing one or more natural and/or artificial lights illuminating the subject. Final 3D asset may be suitable for subsequent modification via traditional visual effects (VFX) techniques, including relighting, animation, expression transfer, and/or texture modification.

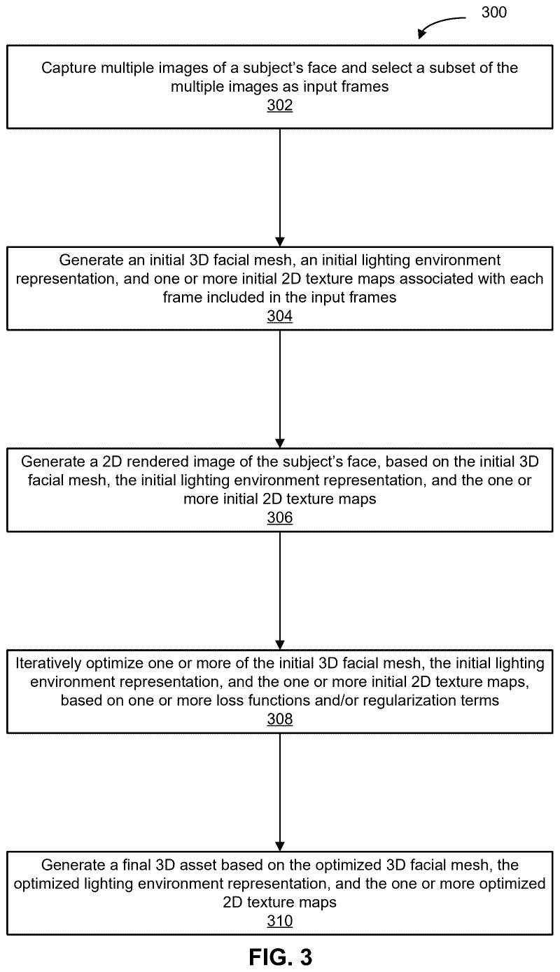

FIG. 3 is a flow diagram of method steps for performing facial capture, according to some embodiments. Although the method steps are described in conjunction with the systems of FIGS. 1-2, persons skilled in the art will understand that any system configured to perform the method steps in any order falls within the scope of the present disclosure.

As shown, in step 302 of method 300, capture engine 122 receives multiple images of a subject's face via capture apparatus 200, and selects a subset of the multiple images as input frames 210. In various embodiments, capture apparatus 200 includes a single still or video camera positioned at a fixed location in front of the subject, and one or more natural and/or artificial light sources arranged in an arbitrary, fixed configuration.

In various embodiments, the camera included in capture apparatus 200 may generate hundreds of images of the subject's face. The images may be captured from a still camera, or as individual frames taken from a video sequence generated by a video camera. The video or still camera may generate the images over a period of time, as the subject rotates their head up, down, to the left, and/or to the right. Capture engine 122 may select a subset of the generated images as input frames 210 via a uniform selection or other suitable selection technique. For example, capture apparatus 200 may capture 500-800 images of the subject's face, and capture engine 122 may select 250 of those images as input frames.

In step 304, preprocessing module 220 generates mesh/maps 230, where mesh/maps 230 may include an initial 3D facial mesh representing a geometry of the subject's face, an initial lighting environment map, and one or more initial 2D texture maps associated with each frame included in input frames 210. In various embodiments, preprocessing module 220 may detect facial landmarks depicted in the input frame, and fit the initial 3D mesh to the detected facial landmarks using a 3D morphable model (3DMM).

Preprocessing module 220 generates an initial diffuse albedo texture map by averaging a projected texture across multiple input frames and computing a piece-wise constant version of the diffuse albedo texture map based on a predefined face segmentation. Preprocessing module 220 generates an initial specular intensity texture map including a greyscale depiction of the generated initial diffuse albedo texture map. Preprocessing module 220 may also generate an initial specular roughness texture map and a 3D environment map representing the static lighting conditions.

In step 306, renderer 240 of capture engine 122 generates a 2D rendered image of the subject's face, based on the initial 3D facial mesh, the initial 3D environment map, and the one or more initial 2D texture maps. In various embodiments, renderer 240 may determine the visibility of one or more points included in the 3D facial mesh using one or more of a shading model or a visibility prior model.

In step 308, capture engine 122 may iteratively optimize one or more of the initial 3D facial mesh, the initial 3D environment map, and the one or more initial 2D texture maps, based on one or more loss functions and/or regularization terms included in a final loss value and computed by loss calculator 250. In various embodiments, the loss functions may include an image loss based on a pixel-wise comparison of the generated 2D rendered image and a corresponding captured image included in input frames 210. The loss functions may also include a mask loss based on a pixel-wise comparison of a binary face mask generated by preprocessing module 220 and a ground truth binary face mask generated by a geometry processing technique such as MODNet.

In various embodiments, the regularization terms may include a Laplacian regularization term, a lighting regularization term, a roughness regularization term, and/or a diffuse albedo regularization term. The Laplacian regularization term encourages the optimized 3D facial mesh to remain close to the initial 3D facial mesh generated by preprocessing module 220. The lighting regularization term is applied to the optimized lighting environment map to enforce the white or near-white lighting color typically associated with natural and artificial light sources. The roughness regularization term encourages smooth transitions between regions of the rendered image having different textures and/or roughness attributes. The diffuse albedo regularization term encourages the diffuse albedo texture map values to remain small, such that specular intensity values associated with regions of the rendered image are not recorded as diffuse albedo texture map values.

Renderer 240 is differentiable, therefore capture engine 122 may iteratively optimize the 3D facial mesh, texture maps, and/or lighting environment maps via a gradient descent technique. In various embodiments, capture engine 122 may optimize the 3D facial mesh, texture maps, and/or lighting environment representation for a predetermined number of iterations. In other embodiments, capture engine 122 may continue the optimization until the final loss function value is below a predetermined threshold.

In step 310, capture engine 122 generates final 3D asset 260 based on the optimized 3D facial mesh, the optimized 3D environment map, and the one or more optimized 2D texture maps. In various embodiments, final 3D asset 260 includes an optimized, high-quality 3D mesh representing the subject's face, as well as optimized diffuse albedo, specular intensity, and roughness texture maps. Final 3D asset 260 may also include an optimized lighting environment representation describing one or more natural and/or artificial lights illuminating the subject. Final 3D asset may be suitable for subsequent modification via traditional visual effects (VFX) techniques, including relighting, animation, expression transfer, and/or texture modification.

In sum, the disclosed techniques generate a three-dimensional (3D) asset including a representation of a facial geometry and a facial skin appearance. The disclosed techniques receive multiple captured images of a subject face, taken from a fixed camera position under arbitrary, fixed lighting. The techniques analyze a subset of the captured images and, for each image in the subset of capture images, initialize a facial geometry representation and one or more texture maps representing skin appearance. The disclosed techniques perform reverse rendering on the facial geometry and texture maps, and calculate one or more loss function values based on a comparison of a rendered image and a corresponding captured image. The disclosed techniques iteratively modify one or more adjustable parameters included in a differentiable renderer based on the one or more calculated loss function values. The generated 3D asset may be modified by subsequent video effects (VFX) operations, such as relighting, texture editing, and/or animation.

In operation, a capture engine receives multiple images of a subject's face from a capture apparatus. The capture apparatus includes a fixed video or still camera positioned in front of the subject, and an arbitrary lighting environment that may include natural lighting and/or one or more artificial light sources. The camera captures multiple (potentially hundreds) of images of the subject's face in a neutral expression, as the subject rotates their head in one or more directions, including left, right, up, or down.

The capture engine selects a set of input frames from the multiple captured images via, e.g., a uniform distribution, and performs pre-processing on each input frame. During pre-processing, the capture engine generates, for each of the input frames, an initial mesh geometry representation of the subject's face, an initial lighting environment map, and one or more initial two-dimensional (2D) texture maps, including diffuse albedo, specular intensity, and/or roughness texture maps.

The capture engine includes a differentiable renderer that generates a 2D image of the subject's face based on the mesh geometry and texture maps associated with an input frame. The renderer determines the visibility of lighting at various locations on the subject's face via one or more of a shading model or a visibility prior model.

The capture engine calculates one or more loss function values based on a comparison of the rendered 2D image and the corresponding captured image. The capture engine also applies regularization terms to each of the lighting environment map, the roughness map, and the diffuse albedo map. The capture engine calculates a final loss value based on the loss functions and regularization terms, and iteratively modifies one or more adjustable parameters included in the differentiable renderer based on the final loss value. The capture engine may continue to modify the adjustable parameters for a fixed number of iterations, or until the final loss value is below a predetermined threshold.

The capture engine generates a final 3D asset representing the subject's face, wherein the 3D asset includes a 3D mesh representation of the subject's facial geometry, and 2D texture maps representing the diffuse albedo, specular intensity, and roughness of the subject's skin surface. The generated 3D asset is suitable for subsequent modification via visual effects (VFX) processing techniques, including relighting and/or animation.

One technical advantage of the disclosed techniques relative to the prior art is that the disclosed techniques require only a single fixed camera and are operable to perform facial capture under arbitrary static lighting conditions. The disclosed techniques do not require high quality 3D face geometry as an input, and correctly model facial self-occlusion while generating appearance maps of the subject, allowing the disclosed techniques to separate shading from the captured facial appearance. Further, the disclosed techniques are operable to estimate the static environment lighting based on captured facial images. These technical advantages provide one or more improvements over prior art approaches.

1. In some embodiments, a computer-implemented method for performing facial capture, the computer-implemented method comprises capturing, via a single camera having a fixed position and under fixed, arbitrary lighting conditions, multiple two-dimensional (2D) images depicting a subject's face, generating, for each of one or more of the 2D images, a three-dimensional (3D) facial mesh, a lighting environment representation, and one or more 2D texture maps, generating a 2D rendered image depicting the subject's face, based at least on the 3D facial mesh, the lighting environment representation, and the one or more 2D texture maps, optimizing one or more of the 3D facial mesh, the lighting environment representation, and the one or more 2D texture maps, based on a final loss value including one or more loss terms and regularization terms, and generating an output 3D asset including an optimized 3D facial mesh, an optimized lighting environment representation, and one or more optimized 2D texture maps

2. The computer-implemented method of clause 1, wherein the single camera comprises a video camera, and each of the multiple 2D images comprises a single frame captured from a video sequence generated by the video camera

3. The computer-implemented method of clauses 1 or 2, wherein the 2D texture maps include one or more of a diffuse albedo texture map, a specular intensity texture map, or a roughness texture map

4. The computer-implemented method of any of clauses 1-3, wherein the generating the three-dimensional (3D) facial mesh, the lighting environment representation, and the one or more 2D texture maps are performed on a subset of the multiple 2D images selected as input frames

5. The computer-implemented method of any of clauses 1-4, wherein the one or more loss terms include an image loss, based on a pixel-wise comparison between the generated 2D rendered image and a corresponding image of the subject included in the multiple 2D images

6. The computer-implemented method of any of clauses 1-5, wherein the lighting environment representation includes a representation of the fixed, arbitrary lighting conditions

7. The computer-implemented method of any of clauses 1-6, further comprising calculating, via a trained machine learning model, a visibility of incoming illumination at one or more locations included in the 3D facial mesh

8. The computer-implemented method of any of clauses 1-7, wherein the 3D facial mesh associated with one of the one or more 2D images is generated by a 3D morphable model, based on one or more facial landmarks detected in the 2D image

9. In some embodiments, one or more non-transitory, computer-readable media store instructions that, when executed by one or more processors, cause the one or more processors to perform the steps of capturing, via a single camera having a fixed position and under fixed, arbitrary lighting conditions, multiple two-dimensional (2D) images depicting a subject's face, generating, for each of one or more of the 2D images, a three-dimensional (3D) facial mesh, a lighting environment representation, and one or more 2D texture maps, generating a 2D rendered image depicting the subject's face, based at least on the 3D facial mesh, the lighting environment representation, and the one or more 2D texture maps, optimizing one or more of the 3D facial mesh, the lighting environment representation, and the one or more 2D texture maps, based on a final loss value including one or more loss terms and regularization terms, and generating an output 3D asset including an optimized 3D facial mesh, an optimized lighting environment representation, and one or more optimized 2D texture maps

10. The one or more non-transitory computer-readable media of clause 9, wherein the single camera comprises a video camera, and each of the multiple 2D images comprises a single frame captured from a video sequence generated by the video camera

11. The one or more non-transitory computer-readable media of clauses 9 or 10, wherein the 2D texture maps include one or more of a diffuse albedo texture map, a specular intensity texture map, or a roughness texture map

12. The one or more non-transitory computer-readable media of any of clauses 9-11, wherein the generating the three-dimensional (3D) facial mesh, the lighting environment representation, and the one or more 2D texture maps are performed on a subset of the multiple 2D images selected as input frames

13. The one or more non-transitory computer-readable media of any of clauses 9-12, wherein the one or more loss terms include an image loss, based on a pixel-wise comparison between the generated 2D rendered image and a corresponding image of the subject included in the multiple 2D images

14. The one or more non-transitory computer-readable media of any of clauses 9-13, wherein the lighting environment representation includes a representation of the fixed, arbitrary lighting conditions

15. The one or more non-transitory computer-readable media of any of clauses 9-14, further comprising calculating, via a trained machine learning model, a visibility of incoming illumination at one or more locations included in the 3D facial mesh

16. The one or more non-transitory computer-readable media of any of clauses 9-15, wherein the 3D facial mesh associated with one of the one or more 2D images is generated by a 3D morphable model, based on one or more facial landmarks detected in the 2D image

17. In some embodiments, a system comprises one or more memories storing instructions, and one or more processors for executing the instructions to capture, via a single camera having a fixed position and under fixed, arbitrary lighting conditions, multiple two-dimensional (2D) images depicting a subject's face, generate, for each of one or more of the 2D images, a three-dimensional (3D) facial mesh, a lighting environment representation, and one or more 2D texture maps, generate a 2D rendered image depicting the subject's face, based at least on the 3D facial mesh, the lighting environment representation, and the one or more 2D texture maps, optimize one or more of the 3D facial mesh, the lighting environment representation, and the one or more 2D texture maps, based on a final loss value including one or more loss terms and regularization terms, and generate an output 3D asset including an optimized 3D facial mesh, an optimized lighting environment representation, and one or more optimized 2D texture maps

18. The system of clause 17, wherein the generating the three-dimensional (3D) facial mesh, the lighting environment representation, and the one or more 2D texture maps are performed on a subset of the multiple 2D images selected as input frames

19. The system of clauses 17 or 18, wherein the one or more loss terms include an image loss, based on a pixel-wise comparison between the generated 2D rendered image and a corresponding image of the subject included in the multiple 2D images

20. The system of any of clauses 17-19, wherein the 3D facial mesh associated with one of the one or more of 2D images is generated by a 3D morphable model, based on one or more facial landmarks detected in the 2D image.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing facial capture, the computer-implemented method comprising:
capturing, via a single camera having a fixed position and under fixed, arbitrary lighting conditions, multiple two-dimensional (2D) images depicting a subject's face;
generating, for each of one or more of the 2D images, a three-dimensional (3D) facial mesh, a lighting environment representation, and one or more 2D texture maps;
generating a 2D rendered image depicting the subject's face, based at least on the 3D facial mesh, the lighting environment representation, and the one or more 2D texture maps;
optimizing one or more of the 3D facial mesh, the lighting environment representation, and the one or more 2D texture maps, based on a final loss value including one or more loss terms and regularization terms; and
generating an output 3D asset including an optimized 3D facial mesh, an optimized lighting environment representation, and one or more optimized 2D texture maps.

2. The computer-implemented method of claim 1, wherein the single camera comprises a video camera, and each of the multiple 2D images comprises a single frame captured from a video sequence generated by the video camera.

3. The computer-implemented method of claim 1, wherein the 2D texture maps include one or more of a diffuse albedo texture map, a specular intensity texture map, or a roughness texture map.

4. The computer-implemented method of claim 1, wherein the generating the three-dimensional (3D) facial mesh, the lighting environment representation, and the one or more 2D texture maps are performed on a subset of the multiple 2D images selected as input frames.

5. The computer-implemented method of claim 1, wherein the one or more loss terms include an image loss, based on a pixel-wise comparison between the generated 2D rendered image and a corresponding image of the subject included in the multiple 2D images.

6. The computer-implemented method of claim 1, wherein the lighting environment representation includes a representation of the fixed, arbitrary lighting conditions.

7. The computer-implemented method of claim 1, further comprising calculating, via a trained machine learning model, a visibility of incoming illumination at one or more locations included in the 3D facial mesh.

8. The computer-implemented method of claim 1, wherein the 3D facial mesh associated with one of the one or more 2D images is generated by a 3D morphable model, based on one or more facial landmarks detected in the 2D image.

9. One or more non-transitory, computer-readable media storing instructions that, when executed by one or more processors, cause the one or more processors to perform the steps of:
capturing, via a single camera having a fixed position and under fixed, arbitrary lighting conditions, multiple two-dimensional (2D) images depicting a subject's face;
generating, for each of one or more of the 2D images, a three-dimensional (3D) facial mesh, a lighting environment representation, and one or more 2D texture maps;
generating a 2D rendered image depicting the subject's face, based at least on the 3D facial mesh, the lighting environment representation, and the one or more 2D texture maps;
optimizing one or more of the 3D facial mesh, the lighting environment representation, and the one or more 2D texture maps, based on a final loss value including one or more loss terms and regularization terms; and
generating an output 3D asset including an optimized 3D facial mesh, an optimized lighting environment representation, and one or more optimized 2D texture maps.

10. The one or more non-transitory computer-readable media of claim 9, wherein the single camera comprises a video camera, and each of the multiple 2D images comprises a single frame captured from a video sequence generated by the video camera.

11. The one or more non-transitory computer-readable media of claim 9, wherein the 2D texture maps include one or more of a diffuse albedo texture map, a specular intensity texture map, or a roughness texture map.

12. The one or more non-transitory computer-readable media of claim 9, wherein the generating the three-dimensional (3D) facial mesh, the lighting environment representation, and the one or more 2D texture maps are performed on a subset of the multiple 2D images selected as input frames.

13. The one or more non-transitory computer-readable media of claim 9, wherein the one or more loss terms include an image loss, based on a pixel-wise comparison between the generated 2D rendered image and a corresponding image of the subject included in the multiple 2D images.

14. The one or more non-transitory computer-readable media of claim 9, wherein the lighting environment representation includes a representation of the fixed, arbitrary lighting conditions.

15. The one or more non-transitory computer-readable media of claim 9, further comprising calculating, via a trained machine learning model, a visibility of incoming illumination at one or more locations included in the 3D facial mesh.

16. The one or more non-transitory computer-readable media of claim 9, wherein the 3D facial mesh associated with one of the one or more 2D images is generated by a 3D morphable model, based on one or more facial landmarks detected in the 2D image.

17. A system comprising:
one or more memories storing instructions; and
one or more processors for executing the instructions to:
capture, via a single camera having a fixed position and under fixed, arbitrary lighting conditions, multiple two-dimensional (2D) images depicting a subject's face;
generate, for each of one or more of the 2D images, a three-dimensional (3D) facial mesh, a lighting environment representation, and one or more 2D texture maps;
generate a 2D rendered image depicting the subject's face, based at least on the 3D facial mesh, the lighting environment representation, and the one or more 2D texture maps;
optimize one or more of the 3D facial mesh, the lighting environment representation, and the one or more 2D texture maps, based on a final loss value including one or more loss terms and regularization terms; and
generate an output 3D asset including an optimized 3D facial mesh, an optimized lighting environment representation, and one or more optimized 2D texture maps.

18. The system of claim 17, wherein the generating the three-dimensional (3D) facial mesh, the lighting environment representation, and the one or more 2D texture maps are performed on a subset of the multiple 2D images selected as input frames.

19. The system of claim 17, wherein the one or more loss terms include an image loss, based on a pixel-wise comparison between the generated 2D rendered image and a corresponding image of the subject included in the multiple 2D images.

20. The system of claim 17, wherein the 3D facial mesh associated with one of the one or more of 2D images is generated by a 3D morphable model, based on one or more facial landmarks detected in the 2D image.
